(19) United States
(12) Patent Application Publication
(10) Pub. No.: US 2025/0104075 A1
(43) Pub. Date: Mar. 27, 2025

(54) MULTILAYER IDENTITY TRANSACTION CONTROL AND VERIFICATION FOR E-COMMERCE TRANSACTIONS

(71) Applicant: Visa International Service Association, San Francisco, CA (US)

(72) Inventors: Rong Zhang, Fremont, CA (US); Sean Nathaniel Barding, Spring Hill, TN (US); Haochuan Zhou, Redwood City, CA (US); Shan Qin, Foster City, CA (US); Shivani Shivanand Suryawanshi, Foster City, CA (US); Clarence Siu, San Francisco, CA (US)

(73) Assignee: Visa International Service Association, San Francisco, CA (US)

(21) Appl. No.: 18/474,729

(22) Filed: Sep. 26, 2023

(51) Int. Cl. G06Q 20/40; G06Q 20/12

(52) U.S. Cl. CPC G06Q 20/4016; G06Q 20/12; G06Q 20/4014; G06Q 20/405; G06Q 20/407

(57) ABSTRACT

Systems and methods for automated transaction control and verification for e-commerce platforms, the method comprising receiving, by a control server, data elements of an e-commerce transaction, wherein each data element of the data elements is of a data element-type of a plurality of data element-types; inputting, by the control server, the data elements in a multi-layer identity verification module; generating, by the multi-layer identity verification module, based on the data elements, a verification score for an identity variable of at least one layer of the multi-layer identity verification module, wherein the identity variable is comprised of at least one of the plurality of data element-types; and directing an e-commerce merchant system to apply a transaction outcome action based on implementation of transaction rules set by the e-commerce merchant system that are based on the verification score.

### TECHNICAL FIELD

The present technology is directed to web security, e-commerce, user security, and authentication for internet services. In particular and without limitation this application is directed to systems and methods for multilayer identity transaction control and verification for e-commerce transactions.

### SUMMARY

In one aspect, the present disclosure provides a method for automated transaction control and verification for e-commerce platforms, the method comprising: receiving, by a control server, data elements of an e-commerce transaction, wherein each data element of the data elements is of a data element-type of a plurality of data element-types; inputting, by the control server, the data elements in a multi-layer identity verification module; generating, by the multi-layer identity verification module, based on the data elements, a verification score for an identity variable of at least one layer of the multi-layer identity verification module, wherein the identity variable is comprised of at least one of the plurality of data element-types, wherein a number of data element-types of identity variables associated with the at least one layer is different to a number of data element-types of identity variables of other layers of the multi-layer identity verification module; and directing an e-commerce merchant system to apply a transaction outcome action based on implementation of transaction rules set by the e-commerce merchant system that are based on the verification score.

In various aspects the data element-types can comprise CC (Credit card) or payment type information, email, IP address, Device ID, Phone number, and Billing address as well as other possible information related to such transactions.

In several aspects the transaction outcome action comprises at least one of an acceptance, a rejection, a pause, a placing of a hold, a fraud chargeback, a credit-back, a marking a non-fraud chargeback, a settlement, or a refund of the e-commerce transaction.

In numerous aspects the method further comprises storing the verification score in a data structure in a database coupled to the control server.

In numerous aspects the method further comprises receiving, by the control server, other data elements related to at least one of the e-commerce transaction, or the data elements, from a third party data source.

In numerous aspects the method further comprises receiving the transaction rules from the e-commerce merchant system

In numerous aspects the method comprises the multi-layer identity verification module being configured to propagate a plurality of identity variables from a plurality of e-commerce transactions; for each identity variable of the plurality of identity variables generate a plurality of temporal variable assessment scores limited to a period of time based on at least one of: a number of transactions, a number of transaction statuses, types of transaction statuses, time-lapsed since transaction statuses, or combinations thereof; and aggregating the plurality of temporal identity assessment scores for each identity variable to produce a raw risk assessment, wherein the raw risk assessment is of a plurality of raw risk assessments corresponding to the plurality of identity variables.

In multiple aspects the method further comprises storing at least one of the plurality of identity variables, the plurality of temporal identity assessment scores, or the plurality of raw risk assessments in a data warehouse coupled to the control server.

In numerous aspects the generating of the verification score of the method, comprises propagating a plurality of identity variables from the data elements of the e-commerce transaction; extracting for each identity variable of the plurality of identity variables a corresponding raw risk assessment from the plurality of raw risk assessments, wherein at least one corresponding raw risk assessment is used as the verification score.

In several aspects, the method further comprises incorporating the data elements into historical data elements in the data warehouse; and updating the plurality of raw risk assessments based on at least one of the data elements, an updated number of transactions, an updated number of transaction statuses, an updated number of types of transaction statuses, an updated time-lapsed since transaction statuses, or combinations thereof.

In many aspects the method further comprises determining the transaction outcome action based on at least one of the verification score, or the transaction rules.

In multiple aspects, the method further comprises pushing at least one of the verification score or the transaction outcome action, by the control server to an e-commerce merchant system.

In several aspects, the method further comprises automatically implementing, by the e-commerce merchant system, the transaction outcome action. In many aspects the actionable selectable options comprise at least one of correcting information, cancelling the e-commerce transaction, confirming the e-commerce transaction, or confirming information.

In one aspect, the present disclosure provides an e-commerce transaction control and verification control system, the system comprising a data warehouse coupled to at least one of an e-commerce merchant system or third party data source; a multi-layer identity verification module coupled to the data warehouse, configured to receive a plurality of e-commerce transaction data from at least one of the data warehouse or the e-commerce merchant system; propagate a plurality of identity variables from the plurality of e-commerce transactions; for each identity variable of the identity variables generate a plurality of temporal identity assessment scores limited to a period of time based on at least one of: a number of transaction statuses, types of transaction statuses, time-lapsed since transaction statuses, or combinations thereof; aggregating the plurality of temporal identity assessment scores to produce a raw risk assessment of a plurality of raw risk assessments, each raw risk assessment of the plurality of raw risk assessments corresponding to an identity variable of the plurality of identity variables; and extracting at least one verification score from the plurality of raw risk assessments.

In several aspects the data warehouse is configured to receive a plurality of historical data from the third party data source; and convert the historical data into e-commerce transaction data to be used as part of the plurality of e-commerce transaction data.

In various aspects the data warehouse is configured to receive a plurality of transaction data from the e-commerce merchant system.

The system wherein the multi-layer identity verification module coupled to the data warehouse, is further configured to determine a transaction outcome action based on at least one of the verification score, or transaction rules. The transaction outcome action comprises at least one of an acceptance, a rejection, a pause, a placing of a hold, a fraud chargeback, a credit-back, a marking a non-fraud chargeback, a settlement, or a refund of the e-commerce transaction.

In many aspects the multi-layer identity verification module coupled to the data warehouse, is further configured to push at least one of the verification score or the transaction outcome action, to an e-commerce merchant system.

In one aspect the present disclosure provides an e-commerce merchant system for automated transaction control and verification, the system comprising a transaction server to receive a request for an e-commerce transaction from a user account; transmit data elements of the e-commerce transaction to a control server; receive at least one of a verification score, or a direction from the control server to apply a transaction outcome action; determine the transaction outcome action based on at least one of the verification score, the direction from the control server, the data elements of the e-commerce transaction, pre-set transaction verification rules, or a combination thereof; and automatically implement the transaction outcome action to the e-commerce transaction.

In various aspects the system further comprises a user interface module to display on an administrator device coupled to the e-commerce merchant system at least one of the verification score, a notification of the transaction outcome action, or an actionable alert.

In numerous aspects the transaction outcome action comprises at least one of an acceptance, a rejection, a pause, a placing of a hold, a fraud chargeback, a credit-back, a marking a non-fraud chargeback, a settlement, or a refund of the e-commerce transaction.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates an architecture of a transaction control and verification system, according to at least one aspect of the present disclosure.

FIG. 2 illustrates a method for e-commerce transaction control and verification, according to at least one aspect of the present disclosure.

FIG. 3 illustrates a method for generating a verification score in systems, devices, and methods for e-commerce transaction control and verification, according to at least one aspect of the present disclosure.

FIG. 4 illustrates a user interface for implementing and displaying processes for e-commerce transaction control and verification, according to at least one aspect of the present disclosure.

FIG. 5 illustrates the relationship between a merchant e-commerce system, control server and a multi-layer identity verification module in systems and methods for e-commerce transaction control and verification, according to at least one aspect of the present disclosure.

FIG. 6 illustrates an example propagation of multi-layered identity variables in systems and methods for e-commerce transaction control and verification, according to at least one aspect of the present disclosure.

FIG. 7 is a block diagram of a computer apparatus with data processing subsystems or components, which a set of instructions to perform any one or more of the methodologies discussed herein may be executed, according to at least one aspect of the present disclosure.

FIG. 8 is a diagrammatic representation of an example system that includes a host machine within which a set of instructions to perform any one or more of the methodologies discussed herein may be executed, according to at least one aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

The proliferation of E-Commerce, online video, and other market platforms facilitating non-physical, card-absent transactions on the internet have led to increased concerns about security and identity/account theft or unauthorized usage. While increasingly secure methods such as biometric authentication have been utilized by some E-commerce platforms, adoption is not universal, and these verification techniques have issues of their own.

E-commerce transactions do not have a ground truth for online identities that can be relied upon to verify a user behind an account or determine who is undertaking a transaction. Current technologies do use some information such as IP or location information to determine information on who is using an account but fail to utilize this information with other information and incorporate it into a fully functional and automated identity verification system.

The present disclosure introduces methods and systems to verify users' identities on e-commerce platforms and other online services (such as subscription services, streaming servicers and the like). The present disclosure provides systems and methods to not only use various data-points and inputs in a system for verification of users but also to combine these various data points and available information about a transaction in multiple layers of complexity, then use that data to verify user authenticity and control transactions on e-commerce platforms and other online services.

Utilizing multilayer identity techniques, systems, and methods not only helps in authenticating users in e-commerce transactions but is also able to reflect and take into account their financial or credit worthiness. For example, if a user purchases an item from an e-commerce merchant, one scenario which is quite common is when authorization of a transaction is declined due to insufficient funds in an account or card. Each of these transaction declinations can be taken into account in the multilayer identity analysis disclosed herein. Therefore, even if a user is determined to be legitimate, their financial status or trustworthiness can be considered and taken into account by the systems and methods disclosed, for example in real-time payments. In several of the aspects described herein, the multilayer identity techniques, systems, and methods are deployed during real-time transactions and can be used to accept, decline, deny, place transactions on hold, or combinations thereof based on for example, authentication of a user or their financial/credit worthiness.

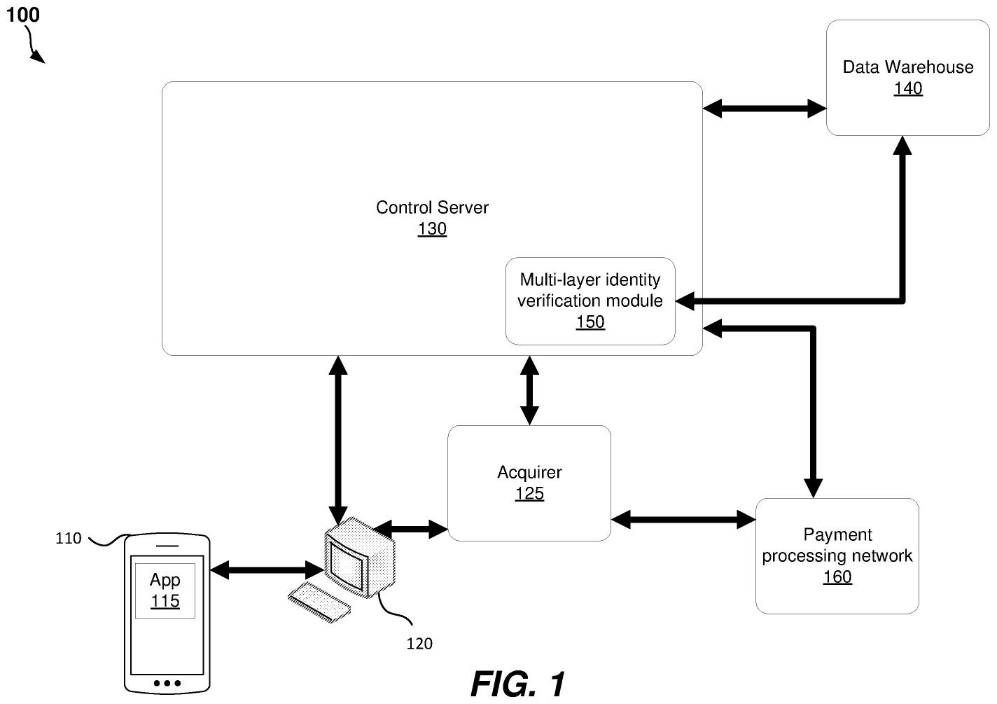

FIG. 1 illustrates an architecture of a transaction control and verification system, according to at least one aspect of the present disclosure. In one aspect, a transaction control and verification system 100 includes a control server 130 that includes a multi-layer identity verification module 150. The multi-layer identity verification module 150 can comprise a combination of software elements and programmable computing devices to produce multi-layer identity verification. The control server 130 can be part of a payment processing network and/or connected to one, and/or it can be part of or connected to a merchant or acquirer system or platform 120 (referred to herein as “merchant platform 120”) to verify and ensure quality control and verification of transactions. The control server 130 can in several aspects be connected to the merchant platform 120, which processes transactions undertaken by a user or client device 110. The user or client device 110 can include an application or other software platform 115 (referred to herein as “app 115”) that connects to the merchant system 120. App 115 facilitates transactions between a user device 110 and a merchant system 120. It can do so for example by providing a software platform on the user device 110 connected to the merchant platform 120 account to conduct a transaction such as the purchase or sale of an item on the merchant platform 120. A merchant platform can include market platforms such as Walmart online shopping™, ebay™ or Amazon™. A merchant platform can also include other online service providers, including streaming or subscription services including Netflix™, Spotify™, Youtube™, Apple Music™ and the like, which facilitate transactions for products and/or services.

In several aspects, system 100 also includes a data warehouse 140 which can include one or more databases or data storage devices connected to each other to make up the data warehouse 140. The data warehouse 140 can connect to the control server 130 and/or the multi-layer identity verification module 150 and transmit historical data to, as well as receive data from either the control server 130 and/or the multi-layer identity verification module 150. In some aspects, the connection is directly between the control server 130 and the data warehouse 140, where transmission of data between the data warehouse 140 and the multi-layer identity verification module 150 are governed by the control server 130. This data that is sent and received between the data warehouse 140 and the control server 130 and/or the multi-layer identity verification module 150 can be live transaction data occurring in real-time, or historical transaction data or post-transaction data for completed or closed transactions or those that have already occurred. In several aspects, the data warehouse 140 can connect directly to the multi-layer identity verification module 150 via one or more communication channels, which can be encrypted.

In some embodiments an acquirer 125 connects the merchant platform 120 with the control server 130, and/or connects merchant platform 120 with a payment processing network 160. In some aspects the control server 130 can connect the acquirer 125 and the merchant platform 120, and in other aspects the control server 130 connects the payment processing network 160 and the acquirer and/or the merchant platform 120. These different variations and permutations of how and where the control server 130 is set up and placed, and how it communicates with and connects the merchant platform 120 and/or the acquirer 125, and the payment processing network 160 allow the control server 130 to take different functions based on authorizations it has from the merchant platform 120, the acquirer 125, or the payment processor network 160, or combinations thereof. For example, in some aspects the control server 130 may control and implement restrictions of action outcomes on transactions in the merchant platform 120, while in other configurations, it may be limited to providing information, directives/instructions, or verification information to merchant platform 120 or any of the other components of the system 100.

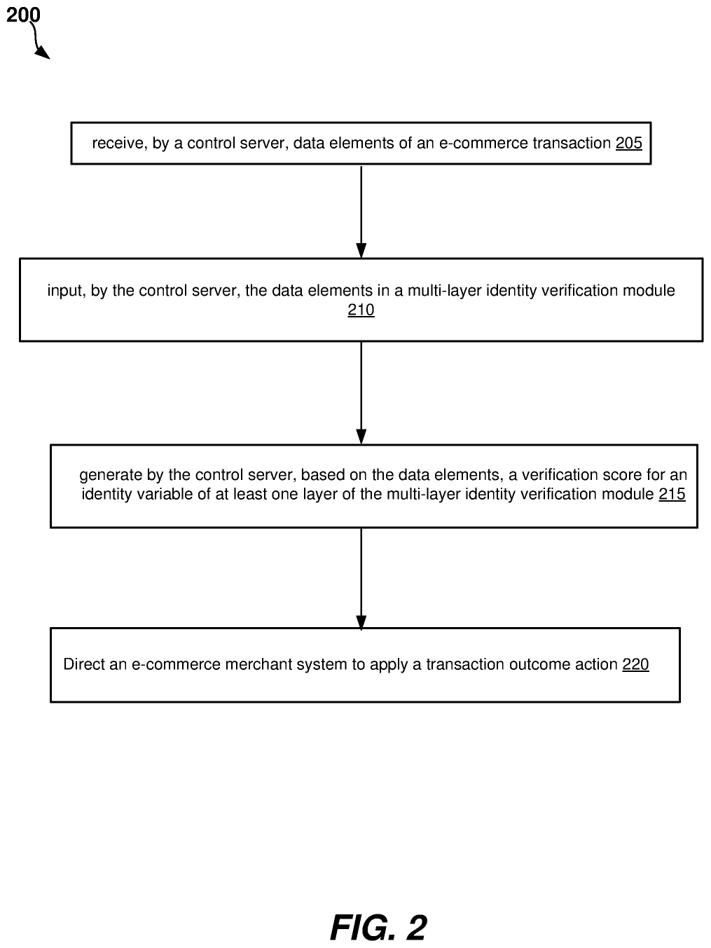

FIG. 2 illustrates a method for e-commerce transaction control and verification, according to at least one aspect of the present disclosure. Referring now primarily to FIG. 2 alongside FIG. 1, in one aspect, a control server, such as the control server 130, FIG. 1 receives 205 data elements of e-commerce transaction(s) from merchant platform 130, and/or in some aspects, receives 205 data of live or historical e-commerce transactions or other web services/online transactions from one or more data sources, wherein in several aspects each data element of the data elements is of a data element-type of a plurality of data element-types. Data elements could include information about a transaction, for example the data elements could be information about a form of payment used in the transaction, such as credit card information, or the data elements could be related to the account used to conduct the transaction, such as the login email, full name of the account holder and other identifiers, as well as other data elements associated to the transaction. The derived, received or collected data elements could be pre-determined by a pre-configuration or pre-determined set-up of the control server 130 and/or the merchant platform 120.

Each data element is associated with a data type of various data types. These data types, and which data type is associated with what element and vice versa can also be pre-configured and implemented by the control server 130. Data types could include types such as “user identifier” to be attached to data elements such as an account user's legal names, date of birth, address and the like. Additional data types could include types such as “email” to be associated to registered emails with the account, or “CC” to be associated to data elements related to credit card information stored or used by the account, for example credit card numbers, expiration dates and the like. In preferred embodiments, exemplary but non-limiting data types may include ‘CC’, ‘IP’ (which relates to data for transaction and/or device IP addresses including real IP addresses), ‘email’, ‘device ID’ (relating to identifiers associated with the user device conducting the transaction/accessing of the merchant platform 120, for example through the app 115, FIG. 1), ‘phone’ and ‘billing address’.

Continuing to refer primarily to FIG. 2 in combination with FIG. 1, the data elements received 205 could be from one or more live transactions or one or more historical transaction, or a combination thereof. In optional aspects, additional data and data elements may be received and/or pulled from external third parties and data vendors. In several embodiments, the control server 130, FIG. 1 inputs 210 these data elements into a multi-layer identity verification module, such as the multi-layer identity verification module 150, FIG. 1. The control server 130 then generates 215, from the input data elements, via the multi-layer identity verification module 150, a verification score for at least one identity variable of at least one layer of the multi-layer identity verification module.

Continuing to refer primarily to FIG. 2 in combination with FIG. 1, in several aspects, the identity variable is comprised of at least one of the plurality of data element-types, wherein the identity variable's element-type make-up is different to that of other identity variables in the data element-types and the element-types the other identity variables are associated with/comprised of. For example, the identity variable could be based on a single data type ‘email’ and its corresponding data element of the user's email used in the transaction, or it could be an identity variable composed of multiple element types or a combination of element types, for example email-IP-CC, corresponding to data elements of the credit card, the email and the IP addresses used in the transaction.

Continuing to refer primarily to FIG. 2 in combination with FIG. 1. One or multiple identity variables could be generated 215 by the control server 130 via the multi-layer identity verification module 150, FIG. 1, this could be determined for example, by the number of pre-set data types and the data elements input 210 that fall within these data types. For example, if only data elements relating to ‘email’ and ‘IP’ are received 205 and then input 210 into the multi-layer identity verification module 150, FIG. 1, then the only possible combinations of computed and generated 215 verification scores would be for the identity variables comprised of the data element-types: ‘IP’, ‘email’, and ‘email-IP’.

Continuing to refer primarily to FIG. 2 in combination with FIG. 1. The multi-layers of the verification module refer to the various numerical combinations of possible data types, with higher layers comprising a higher number of data type combination. For example, the identity variables composed solely of the ‘IP’ data element-type or solely of the ‘email’ data element-type would be from a first layer of possible identity variables, while the identity variable comprised of both the ‘IP-email’ data element-types would be an identity variable of a second layer of possible combinations element types. In various aspects, the control server 130 or the multi-layer identity verification module 150, FIG. 1 must identify all the identity variables associated with the input 205 data elements and their corresponding element types to determine possible identity variables and then generating 215 the verification scores for one or more of these identity variables (this could be, for example, governed by priority or preset configurations that prioritize some identity variables and/or ignore others).

Continuing to refer primarily to FIG. 2 in combination with FIG. 1, based on the generated 215 verification scores for at least one of the identified identity variables, the control server 130 determines based on rules that are preconfigured/pre-set either by the merchant platform 120 and/or by the control server 130 one or more action outcomes for the transaction (referred to herein as “transaction action outcomes” or “action outcomes”). These action outcomes can include for example, and without limitation, acceptance of the transaction, pausing the transaction, placing a hold on the transaction, canceling the transaction, placing a fraud chargeback, providing a credit back to the consumer/user, placing a merchant or system marking on the transaction, placing a non-fraud chargeback on the transaction, settling, asking the user to provide information or answers, refunding the transaction, and the like.

Continuing to refer primarily to FIG. 2 in combination with FIG. 1, in various aspects, the control server 130 directs the-commerce merchant system to apply a transaction outcome action based on implementation of transaction rules set by the e-commerce merchant system that are based on the verification score. Directing 220 could be done by issuing software instructions that include notifications, commands and/or the transmission of verification scores causing the implementation of the transaction outcome action by the merchant platform 120. In various aspects, the control server 130 is authorized to directly implement the action outcome for the merchant platform 120 based on one or more generated 215 verification scores, for example the control server 130 may serve as a transaction control channel between the merchant platform 120 and the payment processing network 160, FIG. 1 where it is authorized to cancel pause or apply transaction action outcomes.

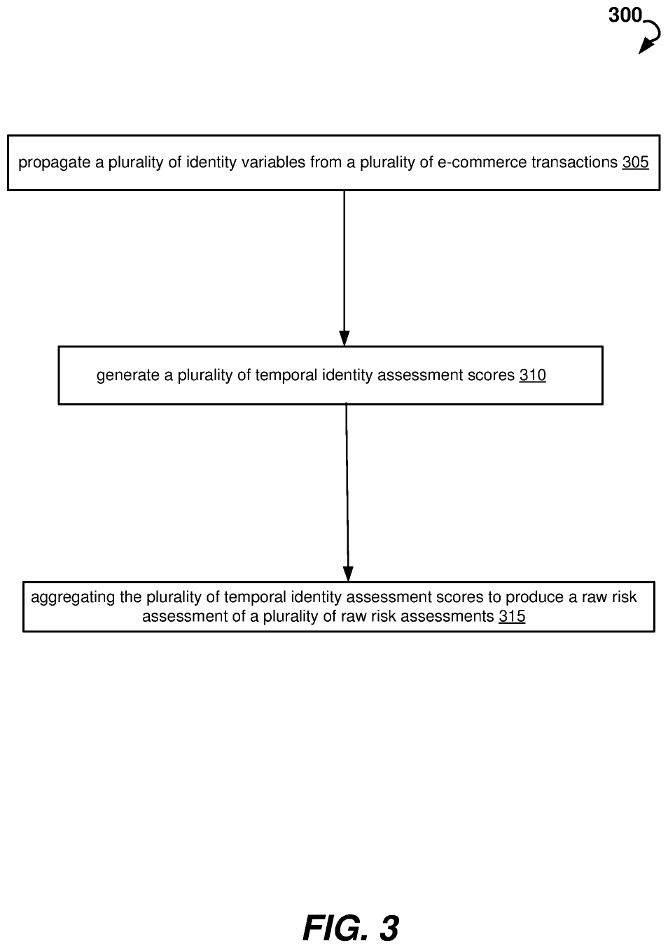

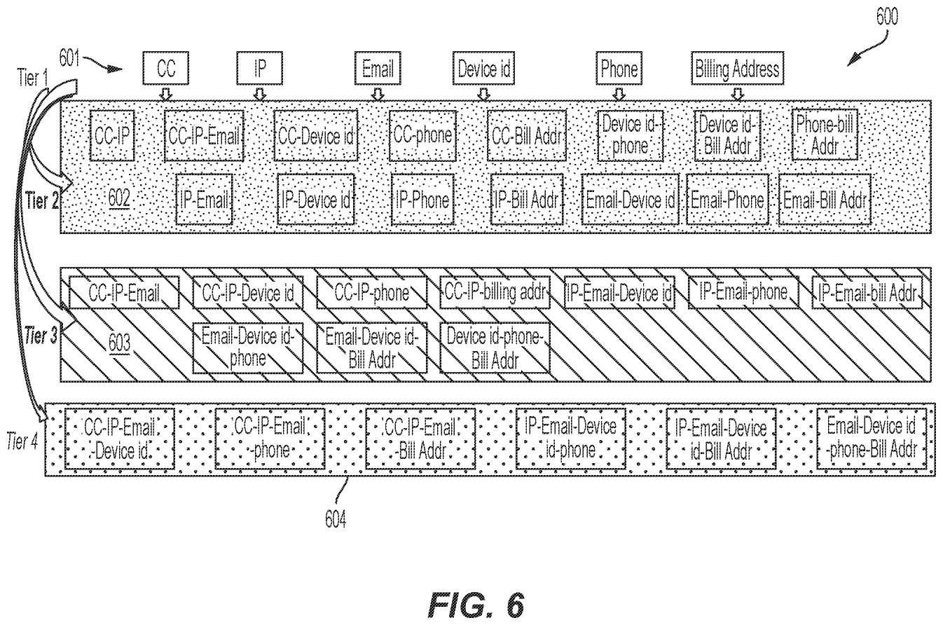

FIG. 3 illustrates a method for generating as verification score in systems, devices, and methods for e-commerce transaction control and verification, according to at least one aspect of the present disclosure. According to one aspect, method 300 comprises a control server and/or a multi-layer identity verification module (such as control server 130, FIG. 1 and the multi-layer identity verification module 150, FIG. 1) propagating 305 from received data inputs a plurality of identity variables, the receiving 205, FIG. 2, can include receiving data of live or historical e-commerce transactions or other web services/online transactions. An example of the propagation 305 of multiple layers of identity variables is provided in FIG. 6. As discussed in relation to FIG. 2, propagation 305 can determine element types associated with the data elements received 205, FIG. 2 and then from those element types can create or propagate multiple layers of element type combinations for example, data elements of types ‘IP’, ‘email’, and ‘CC’ can provide three identity variables of 1 data element-type, i.e., ‘IP’, ‘email’, and ‘CC’, three identity variables of a second layer of 2 data element-type combinations, i.e., the ‘IP and email, ‘CC and email’, and ‘IP and CC’ types, and 1 possible identity variable of 3 data element-types, i.e., ‘IP and CC and email’. Therefore, three levels can be propagated with the data elements input into the multi-layer identity verification module 150, FIG. 1.

In various aspects, a plurality of temporal (i.e., limited to a specific time period or time-frame) identity assessment scores are generated 310 for each identity variable for each identity variable in each of the three layers. Various methods and models can be used, but in preferred aspects, generation 310 of these temporal identity assessment scores are based on historical transactions associated with the specific identity variable and can include first assigning weights to each transaction/transaction outcome identified for the identity variable and propagated 305 identity variables. In one example a table for transactions associated to one of the identity variables can be built, for example:

TABLE 1.0

| | | | | Label_B | Label_C | Label_D | | | |
|---|---|---|---|---|---|---|---|---|---|
| | Decision_A | Decision_B | Label_A | (e.g., | (e.g., | (e.g., No | Label_E | Status_A | Status_B |
| Transaction | (e.g., | (e.g., | (e.g., Fraud | Credit- | Merchant | fraud | (e.g., | (e.g., | (e.g., Week |
| status | Accept) | Reject) | chargeback) | back) | marking) | chargeback) | Settled) | Refund) | of lag) |
| | 30 | 3 | 0 | 0 | 0 | 0 | 20 | 2 | 2 |
| | 12 | 1 | 0 | 0 | 0 | 0 | 10 | 4 | 5 |
| | 45 | 5 | 3 | 2 | 1 | 0 | 32 | 0 | 13 |
| | 113 | 30 | 2 | 1 | 3 | 4 | 112 | 10 | 14 |
| | 34 | 4 | 2 | 5 | 1 | 2 | 6 | 0 | 23 |

Table 1.0 shows the number of types of transaction statuses associated with the identity variable over time, with different weights assigned to each type of transaction status based on one or more of: dates since transaction/week of lag, or the types of transaction statuses, or combinations thereof. In some aspects the identity assessment value can be calculated with the equation: identity assessment=sum_{l,k} tranxstatus_counts_i*tranxstatus_weight_i*time_lag_impact_weight_ik), where tranxstatus_counts_i is the number of transactions of each type of transaction/transaction status of relevance to the identity variable. The variable tranxstatus_weight_i is the assigned weight attached to each type of transaction/transaction status. While the final variable is time_lag_impact_weight_ik which is the time-based weight assigned to each type of transaction/transaction status. The identity assessments for period of time are calculated and then aggregated 315 to determine a raw risk assessment for each identity variable. For example Table 1.1 shows the following identity assessments for the identity variables where identity assessments are calculated for each week in a year and then aggregated to produce an annual identity assessment score or verification score for the identity variables listed:

TABLE 1.1

| CC-email-dID-true IP | Identity assessments (up to 1 year, k = 52) |
|---|---|
| 1234-abc@yahoo.com- | [0.12, , , 0.24, , 0.35, , 0.45, 0.13, 0.32] |
| 08dd2434828c4387ab3b9a26579c03f1- | |
| 191.217.92.158 | |
| 1234-abc@yahoo.com- | [0.22, , 0.34, .003, , 0.12] |
| 08dd2434828c4387ab3b9a26579c03f1- | |
| 191.217.92.100 | |
| dummyCCNo1234- | [0.13, 0.23, 0.34, 0.45, , , 0.56] |
| dummyemail@emailprovider.com- | |
| 08dd2434828c4387ab3b9a26579c03f1- | |
| 100.216.92.158 | |
| 3451-abc@yahoo.com- | [0.34, , , 0.23, 0.12, 0.34, 0.56, 0.55] |
| 08dd2434828c4387ab3b9a26579c03f1- | |
| 191.217.92.158 | |

As can be seen in Table 1.1 the various identity variables are of an element type of 4 layers of a combination of CC-email-dID-true IP (credit card information-email-device identifiers-true IP) with each identity variable provided a raw risk assessment made up of various identity assessments (for example 52 weekly identity assessments) where the final raw risk assessment can be used as a verification score/value of the identity variable or made up of various temporal identity assessment values. The various raw risk assessments for each identity variable can be stored in the data warehouse 140, FIG. 1 or made available to the control server 130 to be used as a threshold to produce action outcomes for live transactions that meet, fall below or exceed a predetermined threshold.

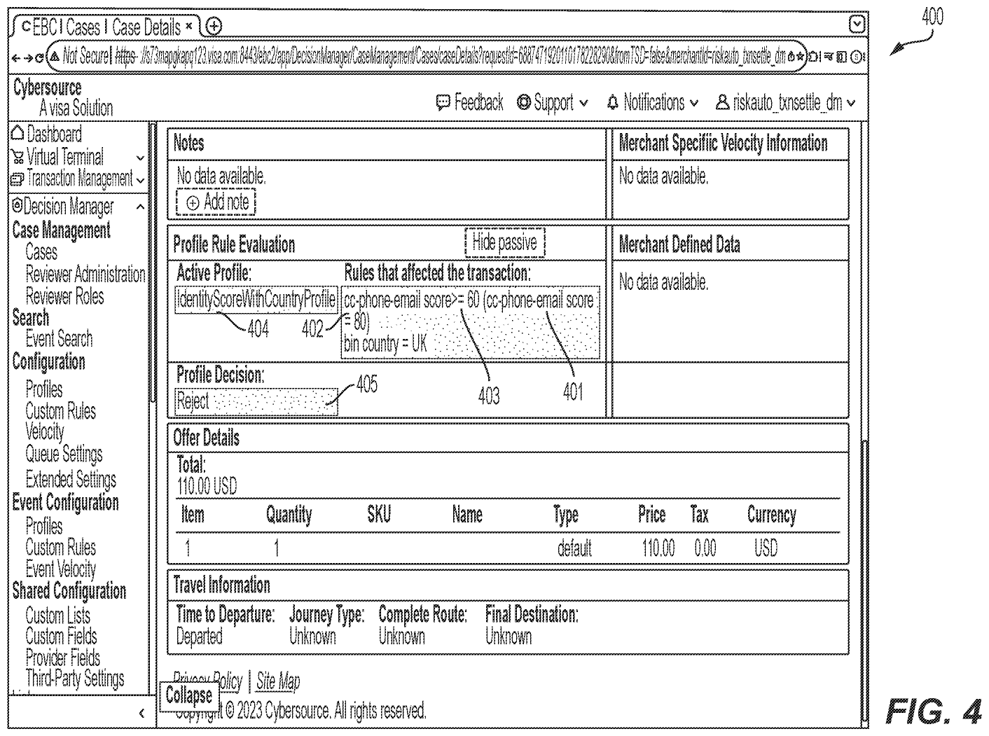

FIG. 4 illustrates a user interface for implementing and displaying processes for e-commerce transaction control and verification, according to at least one aspect of the present disclosure. With reference to FIG. 4 in combination with FIG. 1, user interface 400 can be deployed on a control server 130, FIG. 1, where the user interface 400 (“UI 400”) is displayed to a user or administrator on a display or monitoring screen. The UI 400 can display one or more identity variables 401 with their verification score 402 and can display pre-set rules or thresholds for each identity variables, and action outcomes based on the preset rules 403. For example, the rule 403 sets the threshold for rejecting a transaction with the identity variable 401 of type CC-phone-email to be above or equal to 60. Since in this example the verification score is 80 it meets the requirements for rejection and therefore the control server 130, or the merchant platform 120, FIG. 1 autonomously rejects the transaction. The action outcome is displayed 405 on the UI 400. In various aspects specific pre-set rules such as rule 403 are associated with specific profiles 404 that can include one or more preconfigured rules relating to specific identity variables.

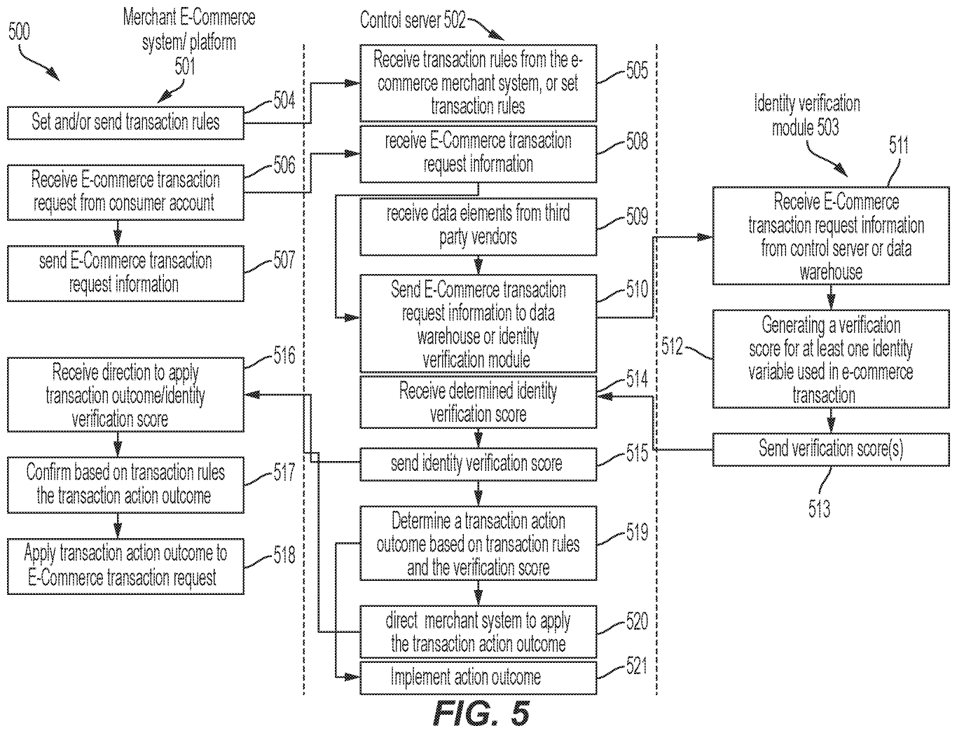

FIG. 5 illustrates the relationship between a merchant e-commerce system, control server and a multi-layer identity verification module in systems and methods for e-commerce transaction control and verification, according to at least one aspect of the present disclosure. With reference primarily to FIG. 5 in combination with references to FIG. 1. In several aspects, the system 500 for multilayer identity transaction control and verification for e-commerce transactions comprises a multi-layer identity verification module 503 (IDM 503) (for example multi-layer identity verification module 150, FIG. 1) that may be connected to or be a part of a control server 502 (for example control server 130, FIG. 1) and/or connected to or be a part of a merchant system or platform 501 (for example merchant platform 120, FIG. 1). In one aspect illustrated herein the merchant platform 501 can set transaction rules including specific thresholds for specific identity variables and action outcomes. The setting of rules 501 may also include communicating, sending 504, or transmitting 504 these rules to the control server 502, which in turn can receive 505 these rules or can set up 505 new rules independently or at least partially based on the received 505 transaction rules.

With primary reference to FIG. 5 alongside reference to FIG. 1, in several aspects, the merchant platform 501 receives 506 an e-commerce transaction or transaction request from a customer or consumer account, for example a user account accessing the merchant platform 501 on a user or client device, such as client device 110, FIG. 1 via app 115, FIG. 1. The transaction request would include data or identifier information associated with it such as an IP of the user device 110 used, the account email, shipping address, as well as various other data points or elements of various element-types. In several aspects the information is sent 507 by the merchant platform 501 to the control server 502 which receives 508 the e-commerce transaction information from the merchant platform 501. The control server 502 can also receive 509 data and information from third party data vendors or fraud protection services, including and not limited to: payment network authorization data, VCAS data, Cardinal, CYBS Decision Manager Transaction data, payment network settlement and refund data, manual review or underwriting decisions, Threatmetrix, Bobj Address Normalized, NA Telecodia Phone Verification, TC 40 fraud chargeback feeds, Issuer bank fraud notification on authentication transactions, and merchant marking or reported suspects. The data received 508, 509 could be about any of data element(s) associated with the transaction/transaction request on the merchant platform 501. This receiving 509 can be done simultaneously with, or be triggered by, the receiving 508, or it could be done in advance as part of periodic data gathering that can store data as part of stored historical transaction data, for example in a data warehouse 140, FIG. 1.

With primary reference to FIG. 5 alongside reference to FIG. 1, in many aspects the control server then sends 510 the data associated to the transaction/transaction request to the IDM 503 which receives 511 it from the control server 502, for example control server 130 FIG. 1 and/or a data warehouse, for example data warehouse 140, FIG. 1. In several aspects the data is sent 510, via the data warehouse 140, FIG. 1. In many aspects some live transaction or transaction request data is received 511 from the control server 502, while also historical data can be received 511 from the data warehouse 140 either directly or indirectly via the control server 502.

With primary reference to FIG. 5 alongside reference to FIG. 1, in numerous aspects, a verification score is generated 512 by the IDM 503 for at least one identity variable from, associated with, or used in the data of the e-commerce transaction/transaction request. Generating 512 of a verification score is explained in detail in FIG. 3. The verification score(s) calculated for the identity variable(s) are sent 513 by the IDM 503 to the control server 502 which receives 514 them, and then the control server 502 in many aspects sends 515 the verification score(s) to the merchant platform 501, which in turn receives 516 these verification scores. In some aspects the control server 502 can also determine 519 an action outcome and direct 520 the merchant platform 501 to implement action outcomes based on the preset rules and/or the verification scores. In many instances the merchant platform 501, based on the rules it had set 504 confirms 517 the correct action outcome it should implement or apply to the transaction/transaction request before applying 518 the action outcome.

With primary reference to FIG. 5 alongside reference to FIG. 1. Once the control server 130, FIG. 1 determines 519 the transaction outcome action, it may be authorized to implement 521 the action outcome itself. These action outcomes can include various action outcomes as described elsewhere in the disclosure along with numerous other possibilities. In some aspects the control server 502 can prevent or allow payments to occur, for example via a payment processing network such as payment processing network 160, FIG. 1.

FIG. 6 illustrates an example for propagation of multi-layered identity variables in systems and methods for e-commerce transaction control and verification, according to at least one aspect of the present disclosure. In this propagation example 600, the element types 601 derived from ingested or input data into a multi-layer identity verification module comprise six element types: CC, IP, Email, Device ID, Phone, and Billing Address. These can be propagated into 6 layers where the highest layer comprises all 6 data types (only 4 layers are shown for illustrative purposes). A first layer 601 comprises each identity variable type on its own, then a second layer 602 comprises combinations of two element types, e.g., CC-IP, IP-email, and the like, a third layer 603 comprises three element types, for example Email-device ID-phone, then a fourth layer 604 includes element types comprising four element types such as CC-IP-Email-Phone.

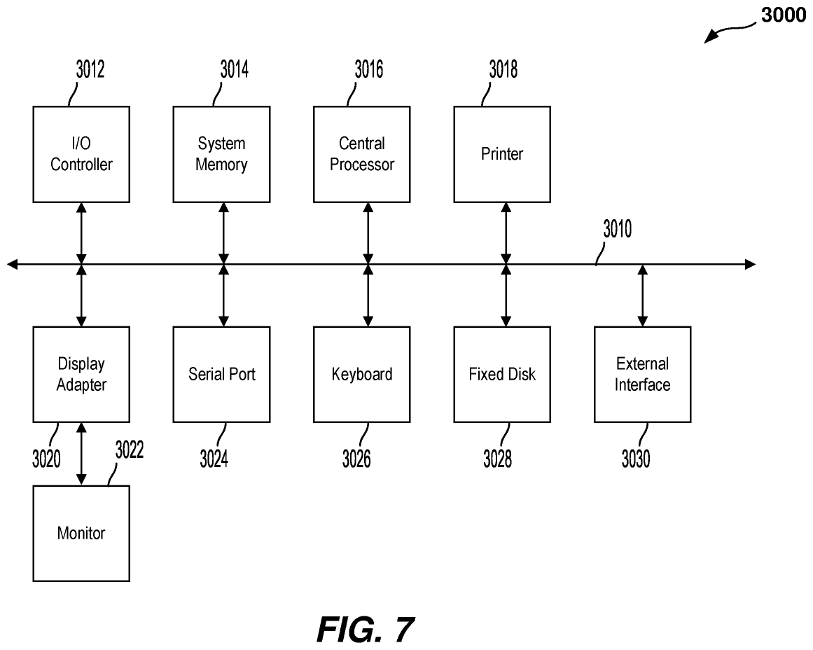

FIG. 7 is a block diagram of a computer apparatus 3000 with data processing subsystems or components, which a set of instructions to perform any one or more of the methodologies discussed herein may be executed, according to at least one aspect of the present disclosure. The subsystems shown in FIG. 7 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

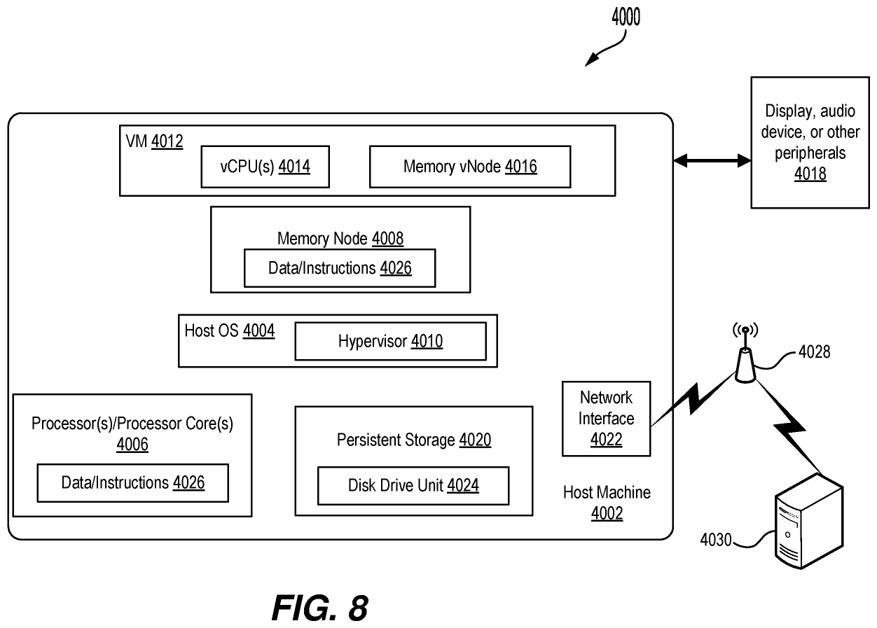

FIG. 8 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

Some descriptions of terms used herein are provided below.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

“Account credentials” may include any information that identifies an account and allows a payment processor to verify that a device, person, or entity has permission to access the account. For example, account credentials may include an account identifier (e.g., a PAN), a token (e.g., account identifier substitute), an expiration date, a cryptogram, a verification value (e.g., card verification value (CVV)), personal information associated with an account (e.g., address, etc.), an account alias, or any combination thereof. Account credentials may be static or dynamic such that they change over time. Further, in some embodiments or aspects, the account credentials may include information that is both static and dynamic. For example, an account identifier and expiration date may be static but a cryptogram may be dynamic and change for each transaction. Further, in some embodiments or aspects, some or all of the account credentials may be stored in a secure memory of a user device. The secure memory of the user device may be configured such that the data stored in the secure memory may not be directly accessible by outside applications and a payment application associated with the secure memory may be accessed to obtain the credentials stored on the secure memory. Accordingly, a mobile application may interface with a payment application in order to gain access to payment credentials stored on the secure memory.

Further, the term “account credential,” “account number,” or “payment credential” may refer to any suitable information associated with an account (e.g., a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

The term “account data,” as used herein, refers to any data concerning one or more accounts for one or more users. Account data may include, for example, one or more account identifiers, user identifiers, transaction histories, balances, credit limits, issuer institution identifiers, and/or the like.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the terms “client” and “client device” may refer to one or more client-side devices or systems (e.g., remote from a transaction service provider) used to initiate or facilitate a transaction (e.g., a payment transaction). Moreover, a “client” may also refer to an entity (e.g., a merchant, an acquirer, and/or the like) that owns, utilizes, and/or operates a client device for initiating transactions (e.g., for initiating transactions with a transaction service provider).

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system. A client or user device may also include an access device as defined in this application.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction

As used herein, the term “comprising” is not intended to be limiting but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “merchant application” may include any application associated with a relying party to a transaction. For example, a merchant mobile application may be associated with a particular merchant or may be associated with a number of different merchants. In some embodiments or aspects, the merchant mobile application may store information identifying a particular merchant server computer that is configured to provide a sales environment in which the merchant server computer is capable of processing remote transactions initiated by the merchant application. Further, the merchant mobile application may also include a general purpose browser or other software designed to interact with one or more merchant server computers. In some cases, the merchant mobile application may be installed in the general purpose memory of a user device and thus, may be susceptible to malicious attacks.

As used herein, a “mobile device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g., when a device has remote access to a network by tethering to another device—e.g., using the other device as a modem-both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

A “payment device” may refer to any device that may be used to conduct a financial transaction, such as to provide payment information to a merchant. A payment device may be in any suitable form. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. For example, suitable payment devices can be hand-held and compact so that they can fit into a consumer's wallet and/or pocket (e.g., pocket-sized). They may include smart cards, debit devices (e.g., a debit card), credit devices (e.g., a credit card), stored value devices (e.g., a stored value card or “prepaid” card), magnetic stripe cards, keychain devices (such as the Speedpass™ commercially available from Exxon-Mobil Corp.), etc. Other examples of payment devices include cellular or wireless telephones (e.g., a smartphone), personal digital assistants (PDAs), portable computer (e.g., tablet or laptop computer), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. In some non-limiting embodiments or aspects, a payment device may include an electronic payment device, such as a smartcard, a chip card, integrated circuit card, and/or the like. An electronic payment device may include an embedded integrated circuit and the embedded integrated circuit may include a data storage medium (e.g., volatile and/or non-volatile memory) to store information associated with the payment device, such as an account identifier, a name of the account holder, and/or the like. The payment device may interface with an access device such as a point-of-sale device to initiate the transaction. In some embodiments or aspects, a mobile device can function as a payment device (e.g., a mobile device can store and be able to transmit payment credentials for a transaction). Further, a payment device may be associated with a value such as a monetary value, a discount, or store credit, and a payment device may be associated with an entity such as a bank, a merchant, a payment processing network, or a person. A payment device may be used to make a payment transaction.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “payment processing network” may refer to a system that receives accumulated transaction information from the gateway processing service, typically at a fixed time each day, and performs a settlement process. Settlement may involve posting the transactions to the accounts associated with the payment devices used for the transactions and calculating the net debit or credit position of each user of the payment devices. An exemplary payment processing network is Interlink®.

As used herein, the term “product” may refer to one or more goods and/or services offered by a merchant.

“Provisioning” may include a process of providing data for use. For example, provisioning may include providing, delivering, or enabling a token on a device. Provisioning may be completed by any entity within or external to the transaction processing system. For example, in some embodiments or aspects, tokens may be provisioned by an issuer or a payment processing network onto a mobile device of a consumer (e.g., account holder). The provisioned tokens may have corresponding token data stored and maintained in the token vault or token registry. In some embodiments or aspects, a token vault or token registry may generate a token that may then be provisioned or delivered to a device. In some embodiments or aspects, an issuer may specify a token range from which token generation and provisioning can occur. Further, in some embodiments or aspects, an issuer may generate and notify a token vault of a token value and provide the token record information (e.g., token attributes) for storage in the token vault.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that are recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, the term “system” may refer to one or more computing devices or combinations of computing devices (e.g., processors, servers, client devices, software applications, components of such, and/or the like).

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

“User information” may include any information that is associated with a user. For example, the user information may include a device identifier of a device that the user owns or operates and/or account credentials of an account that the user holds. A device identifier may include a unique identifier assigned to a user device that can later be used to verify the user device. In some embodiments or aspects, the device identifier may include a device fingerprint. The device fingerprint may an aggregation of device attributes. The device fingerprint may be generated by a software development kit (SDK) provided on the user device using, for example, a unique identifier assigned by the operating system, an International Mobile Station Equipment Identity (IMEI) number, operating system (OS) version, plug-in version, and the like.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.

Clause 1. A method for automated transaction control and verification for e-commerce platforms, the method comprising receiving, by a control server, data elements of an e-commerce transaction, wherein each data element of the data elements is of a data element-type of a plurality of data element-types; inputting, by the control server, the data elements in a multi-layer identity verification module; generating, by the multi-layer identity verification module, based on the data elements, a verification score for an identity variable of at least one layer of the multi-layer identity verification module, wherein the identity variable is comprised of at least one of the plurality of data element-types, wherein a number of data element-types of identity variables associated with the at least one layer is different to a number of data element-types of identity variables of other layers of the multi-layer identity verification module; and directing an e-commerce merchant system to apply a transaction outcome action based on implementation of transaction rules set by the e-commerce merchant system that are based on the verification score.

Clause 2. The method of Clause 1 wherein the transaction outcome action comprises at least one of an acceptance, a rejection, a pause, a placing of a hold, a fraud chargeback, a credit-back, a marking a non-fraud chargeback, a settlement, or a refund of the e-commerce transaction.

Clause 3. The method of any of Clauses 1-2 further comprising storing the verification score in a data structure in a database coupled to the control server.

Clause 4. The method of any of Clauses 1-3 further comprising receiving, by the control server, other data elements related to at least one of the e-commerce transaction, or the data elements, from a third party data source.

Clause 5. The method of any of Clauses 1-4 further comprising receiving the transaction rules from the e-commerce merchant system.

Clause 6. The method of any of Clauses 1-5 wherein the multi-layer identity verification module is configured to propagate a plurality of identity variables from a plurality of e-commerce transactions; for each identity variable of the plurality of identity variables generate a plurality of temporal variable assessment scores limited to a period of time based on at least one of: a number of transactions, a number of transaction statuses, types of transaction statuses, time-lapsed since transaction statuses, or combinations thereof; and aggregating the plurality of temporal identity assessment scores for each identity variable to produce a raw risk assessment, wherein the raw risk assessment is of a plurality of raw risk assessments corresponding to the plurality of identity variables.

Clause 7. The method of any of Clauses 1-6 further comprising storing at least one of the plurality of identity variables, the plurality of temporal identity assessment scores, or the plurality of raw risk assessments in a data warehouse coupled to the control server.

Clause 8. The method of any of Clauses 1-7 wherein the generating of the verification score comprises propagating a plurality of identity variables from the data elements of the e-commerce transaction; and extracting for each identity variable of the plurality of identity variables a corresponding raw risk assessment from the plurality of raw risk assessments, wherein at least one corresponding raw risk assessment is used as the verification score.

Clause 9. The method of any of Clauses 1-8 further comprising incorporating the data elements into historical data elements in the data warehouse; and updating the plurality of raw risk assessments based on at least one of the data elements, an updated number of transactions, an updated number of transaction statuses, an updated number of types of transaction statuses, an updated time-lapsed since transaction statuses, or combinations thereof.

Clause 10. The method of any of Clauses 1-9 further comprising determining the transaction outcome action based on at least one of the verification score, or the transaction rules.

Clause 11. The method of any of Clauses 1-10 further comprising pushing at least one of the verification score or the transaction outcome action, by the control server to an e-commerce merchant system.

Clause 12. The method of any of Clauses 1-11, further comprising automatically implementing, by the e-commerce merchant system, the transaction outcome action.

Clause 13. The method of any of Clauses 1-12, further comprising displaying via a user interface on a user device undertaking the e-commerce transaction, at least of one a notification of the verification score or actionable selectable options to respond to the transaction outcome action.

Clause 14. The method of any of Clauses 1-13, wherein the actionable selectable options comprise at least one of correcting information, cancelling the e-commerce transaction, confirming the e-commerce transaction, or confirming information.

Clause 15. An e-commerce transaction control and verification control system, the system comprising a data warehouse coupled to at least one of an e-commerce merchant system or third party data source; a multi-layer identity verification module coupled to the data warehouse, configured to: receive a plurality of e-commerce transaction data from at least one of the data warehouse or the e-commerce merchant system; propagate a plurality of identity variables from the plurality of e-commerce transactions; for each identity variable of the identity variables generate a plurality of temporal identity assessment scores limited to a period of time based on at least one of: a number of transaction statuses, types of transaction statuses, time lapsed since transaction statuses, or combinations thereof; aggregating the plurality of temporal identity assessment scores to produce a raw risk assessment of a plurality of raw risk assessments, each raw risk assessment of the plurality of raw risk assessments corresponding to an identity variable of the plurality of identity variables; and extracting at least one verification score from the plurality of raw risk assessments.

Clause 16. The system of Clause 15 wherein the data warehouse is configured to receive a plurality of historical data from the third party data source; and convert the historical data into e-commerce transaction data to be used as part of the plurality of e-commerce transaction data.

Clause 17. The system of any of Clauses 15-16 wherein the data warehouse is configured to receive a plurality of transaction data from the e-commerce merchant system.

Clause 18. The system of any of Clauses 15-17 wherein the multi-layer identity verification module coupled to the data warehouse, is further configured to determine a transaction outcome action based on at least one of the verification score, or transaction rules.

Clause 19. The system of any of Clauses 15-18 wherein the transaction outcome action comprises at least one of an acceptance, a rejection, a pause, a placing of a hold, a fraud chargeback, a credit-back, a marking a non-fraud chargeback, a settlement, or a refund of the e-commerce transaction.

Clause 20. The system of any of Clauses 15-19 wherein the multi-layer identity verification module coupled to the data warehouse, is further configured to push at least one of the verification score or the transaction outcome action, to an e-commerce merchant system.

Clause 21. An e-commerce merchant system for automated transaction control and verification, the system comprising a transaction server to receive a request for an e-commerce transaction from a user account; transmit data elements of the e-commerce transaction to a control server; receive at least one of a verification score, or a direction from the control server to apply a transaction outcome action; determine the transaction outcome action based on at least one of the verification score, the direction from the control server, the data elements of the e-commerce transaction, pre-set transaction verification rules, or a combination thereof; and automatically implement the transaction outcome action to the e-commerce transaction.

Clause 22. The system of Clause 21 further comprising a user interface module to display on an administrator device coupled to the e-commerce merchant system at least one of the verification score, a notification of the transaction outcome action, or an actionable alert.

Clause 23. The system of any of Clauses 21-22 wherein the transaction outcome action comprises at least one of an acceptance, a rejection, a pause, a placing of a hold, a fraud chargeback, a credit-back, a marking a non-fraud chargeback, a settlement, or a refund of the e-commerce transaction.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for automated transaction control and verification for e-commerce platforms, the method comprising:
receiving, by a control server, data elements of an e-commerce transaction, wherein each data element of the data elements is of a data element-type of a plurality of data element-types;
inputting, by the control server, the data elements in a multi-layer identity verification module;
generating, by the multi-layer identity verification module, based on the data elements, a verification score for an identity variable of at least one layer of the multi-layer identity verification module, wherein the identity variable is comprised of at least one of the plurality of data element-types, wherein a number of data element-types of identity variables associated with the at least one layer is different to a number of data element-types of identity variables of other layers of the multi-layer identity verification module; and
directing an e-commerce merchant system to apply a transaction outcome action based on implementation of transaction rules set by the e-commerce merchant system that are based on the verification score.

2. The method of claim 1, wherein the transaction outcome action comprises at least one of an acceptance, a rejection, a pause, a placing of a hold, a fraud chargeback, a credit-back, a marking a non-fraud chargeback, a settlement, or a refund of the e-commerce transaction.

3. The method of claim 1 further comprising:
storing the verification score in a data structure in a database coupled to the control server.

4. The method of claim 1, further comprising:
receiving, by the control server, other data elements related to at least one of the e-commerce transaction, or the data elements, from a third party data source.

5. The method of claim 1 further comprising:
receiving the transaction rules from the e-commerce merchant system.

6. The method of claim 1, wherein the multi-layer identity verification module is configured to:
propagate a plurality of identity variables from a plurality of e-commerce transactions;
for each identity variable of the plurality of identity variables generate a plurality of temporal variable assessment scores limited to a period of time based on at least one of: a number of transactions, a number of transaction statuses, types of transaction statuses, time-lapsed since transaction statuses, or combinations thereof; and
aggregating the plurality of temporal identity assessment scores for each identity variable to produce a raw risk assessment, wherein the raw risk assessment is of a plurality of raw risk assessments corresponding to the plurality of identity variables.

7. The method of claim 6 further comprising:
storing at least one of the plurality of identity variables, the plurality of temporal identity assessment scores, or the plurality of raw risk assessments in a data warehouse coupled to the control server.

8. The method of claim 6, wherein the generating of the verification score comprises:
propagating a plurality of identity variables from the data elements of the e-commerce transaction; and
extracting for each identity variable of the plurality of identity variables a corresponding raw risk assessment from the plurality of raw risk assessments, wherein at least one corresponding raw risk assessment is used as the verification score.

9. The method of claim 7, further comprising:
incorporating the data elements into historical data elements in the data warehouse; and
updating the plurality of raw risk assessments based on at least one of the data elements, an updated number of transactions, an updated number of transaction statuses, an updated number of types of transaction statuses, an updated time-lapsed since transaction statuses, or combinations thereof.

10. The method of claim 6 further comprising:
determining the transaction outcome action based on at least one of the verification score, or the transaction rules.

11. The method of claim 6 further comprising:
pushing at least one of the verification score or the transaction outcome action, by the control server to an e-commerce merchant system.

12. The method of claim 8, further comprising:
automatically implementing, by the e-commerce merchant system, the transaction outcome action.

13. The method of claim 1, further comprising:
displaying via a user interface on a user device undertaking the e-commerce transaction, at least of one a notification of the verification score or actionable selectable options to respond to the transaction outcome action.

14. The method of claim 13, wherein the actionable selectable options comprise at least one of correcting information, cancelling the e-commerce transaction, confirming the e-commerce transaction, or confirming information.

15. An e-commerce transaction control and verification control system, the system comprising:
a data warehouse coupled to at least one of an e-commerce merchant system or third party data source;
a multi-layer identity verification module coupled to the data warehouse, configured to:
receive a plurality of e-commerce transaction data from at least one of the data warehouse or the e-commerce merchant system;
propagate a plurality of identity variables from the plurality of e-commerce transactions;
for each identity variable of the identity variables generate a plurality of temporal identity assessment scores limited to a period of time based on at least one of: a number of transaction statuses, types of transaction statuses, time lapsed since transaction statuses, or combinations thereof;
aggregating the plurality of temporal identity assessment scores to produce a raw risk assessment of a plurality of raw risk assessments, each raw risk assessment of the plurality of raw risk assessments corresponding to an identity variable of the plurality of identity variables; and
extracting at least one verification score from the plurality of raw risk assessments.

16. The system of claim 15, wherein the data warehouse is configured to:
receive a plurality of historical data from the third party data source; and
convert the historical data into e-commerce transaction data to be used as part of the plurality of e-commerce transaction data.

17. The system of claim 15, wherein the data warehouse is configured to receive a plurality of transaction data from the e-commerce merchant system.

18. The system of claim 15 wherein the multi-layer identity verification module coupled to the data warehouse, is further configured to:
determine a transaction outcome action based on at least one of the verification score, or transaction rules.

19. The system of claim 15, wherein the transaction outcome action comprises at least one of an acceptance, a rejection, a pause, a placing of a hold, a fraud chargeback, a credit-back, a marking a non-fraud chargeback, a settlement, or a refund of the e-commerce transaction.

20. The system of claim 15 wherein the multi-layer identity verification module coupled to the data warehouse, is further configured to:
push at least one of the verification score or the transaction outcome action, to an e-commerce merchant system.

21. An e-commerce merchant system for automated transaction control and verification, the system comprising a transaction server to:
receive a request for an e-commerce transaction from a user account;
transmit data elements of the e-commerce transaction to a control server;
receive at least one of a verification score, or a direction from the control server to apply a transaction outcome action;
determine the transaction outcome action based on at least one of the verification score, the direction from the control server, the data elements of the e-commerce transaction, pre-set transaction verification rules, or a combination thereof; and
automatically implement the transaction outcome action to the e-commerce transaction.

22. The system of claim 21 further comprising a user interface module to:
display on an administrator device coupled to the e-commerce merchant system at least one of the verification score, a notification of the transaction outcome action, or an actionable alert.

23. The system of claim 21, wherein the transaction outcome action comprises at least one of an acceptance, a rejection, a pause, a placing of a hold, a fraud chargeback, a credit-back, a marking a non-fraud chargeback, a settlement, or a refund of the e-commerce transaction.
